(19) United States
(12) Patent Application Publication
(10) Pub. No.: US 2005/0180071 A1
(43) Pub. Date: Aug. 18, 2005

(54) Circuit and method for ESD protection

(76) Inventors: Yi-Hsun Wu, Hsin-Chu (TW); Jian-Hsing Lee, Hsin-chu (TW); Tongehen Ong, Chong-Her city (TW)

Correspondence Address: DUANE MORRIS, LLP;IP DEPARTMENT, ONE LIBERTY PLACE, PHILADELPHIA, PA, 19103-7396, US

(21) Appl. No.: 10/779,341

(22) Filed: Feb. 13, 2004

(51) Int. Cl. H02H 9/00

(52) U.S. Cl. 361/56

(57) ABSTRACT

A circuit and a method for ESD protection are disclosed. The circuit includes an ESD protection circuit coupled to a pad. A device is coupled to the pad and an internal circuit. The device generates a voltage drop between the pad and the internal circuit, protecting thin oxide layers of the internal circuit from damage. The method comprises coupling an internal circuit to an ESD protection circuit and generating a voltage drop between a pad and the internal circuit to protect thin oxide layers of the internal circuit from damage when an ESD pulse is coupled to the pad.

### FIELD OF THE INVENTION

The present invention relates to a circuit and a method for semiconductor integrated circuits. More particularly, the present invention relates to a circuit and a method for electrostatic damage (ESD) protection.

### DESCRIPTION OF THE RELATED ART

Because of high level integration of semiconductor integrated circuits, product reliabilities are important for the integrated circuits, e.g. vulnerability to electrostatic damage (ESD). An ESD pulse may occur when pins and/or input/output bond pads of the integrated circuits are charged with a high voltage or from current resulting from a body or material that is statically charged. Usually the voltage charge is more than 100V for a short period time, e.g. about 10 to several hundred nanoseconds (ns). Internal devices of the integrated circuits typically cannot suffer the abnormal voltage pulse resulting from the short but sharp voltage or current pulse, and are often easily destroyed. Therefore, ESD protection circuits are designed and connected to pads and the internal integrated circuits to provide an additional current path for bypassing the voltage or current pulse to a safe connection point.

Usually, an ESD protection circuit is triggered under high field strengths in conjunction with PNP and NPN bipolar transistors, which together form a silicon controlled rectifier (SCR). However, the triggering voltage of the ESD protection circuit must be low enough to prevent gate oxide breakdown of the MOS devices within an internal circuit. More specially, it is difficult to design a low capacitance ESD (LCESD) protection circuit while protecting the thin gate oxide from an ESD pulse because additional devices designed in a LCESD protection circuit will increase the capacitance of the circuit.

FIG. 1 schematically illustrates a conventional LCESD protection circuit. Input/output (I/O) pad 110 is coupled to a first connector of LCESD protection circuit 120. A second connector of LCESD protection circuit 120 is coupled to a V_{SS} terminal, e.g. ground. I/O pad 110 is also connected to functional circuit 130 which may further include an inverter or other buffer circuit, e.g NMOS transistors 131 and 132, and internal circuit 133. The source terminal of NMOS transistor 132 is coupled to a V_{SS} terminal.

When an ESD pulse is coupled to I/O pad 110, LCESD protection circuit 120 will be triggered to protect functional circuit 130. However, the thin gate oxide layers of NMOS transistors 131 and 132 may be broken down before LCESD protection circuit 120 is triggered. Therefore, LCESD protection circuit 120 cannot efficiently protect functional circuit 130 from damage resulting from the ESD pulse.

Therefore, it is desirable to provide a circuit and a method to resolve the issues within the semiconductor integrated circuits mentioned above.

### BRIEF DESCRIPTION OF THE DRAWINGS

FIG. 1 schematically illustrates an ESD protection circuit in accordance with a prior art.

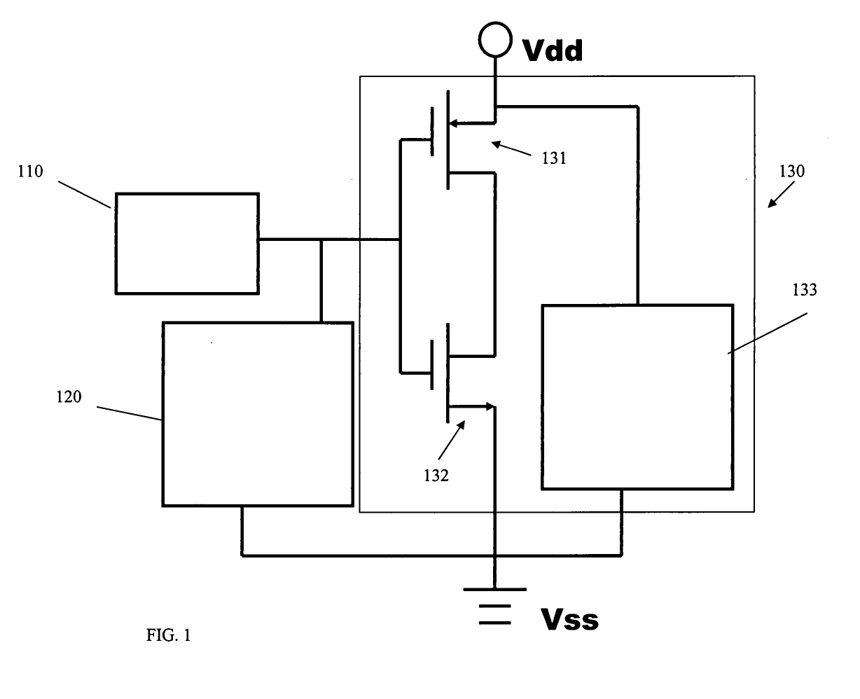

FIG. 2 schematically illustrates an exemplary embodiment of a circuit for ESD protection in accordance with the present invention.

### DESCRIPTION OF A PREFERRED EMBODIMENT

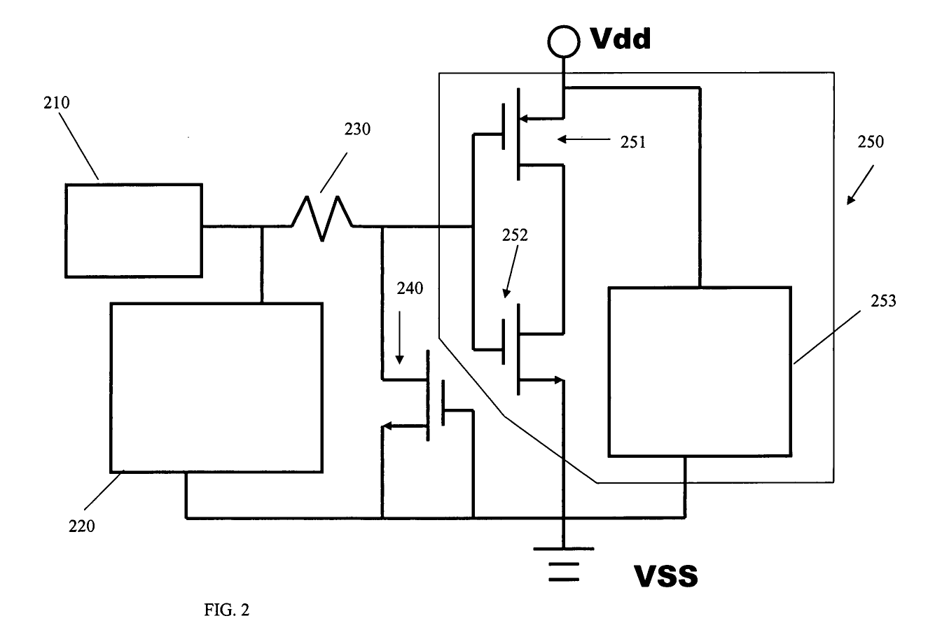

FIG. 2 illustrates a preferred embodiment of a circuit for ESD protection. The circuit comprises pad 210, functional circuit 250, ESD protection circuit 220 operatively coupled to pad 210 and functional circuit 250, first resistive device 230 coupled to pad 210 and functional circuit 250, and active device 240 operatively coupled to first resistive device 230 and ESD protection circuit 220.

Pad 210 may be coupled to a first connector of ESD protection circuit 220 and to resistive device 230. Pad 210 can be, for example, an input/output power pad or an input/output signal pad.

ESD protection circuit 220 can be, for example, a traditional ESD protection circuit or low capacitance ESD (LCESD) protection circuit. A second connector of ESD protection circuit 220 may be coupled to a V_{SS} terminal and V_{SS} may further be operatively coupled to ground.

Resistive device 230 may be connected intermediate pad 210 and functional circuit 250, e.g. to gates of NMOS inverter transistors 251 and 252. Resistive device 230 may be used to effect a voltage drop between pad 210 and functional circuit 250 and can be a resistor, a diode, a transistor, or the like, or a combination thereof. In the embodiment illustrated in FIG. 2, resistive device 230 is a resistor with an impedance of from about 1 ohm to about 100 ohms.

Parasitic capacitance of resistive device 230 should not be so high that resistance-capacitance (RC) delay of the circuit will substantially degrade the performance of the overall circuit. Accordingly, parasitic capacitance of resistive device 230 may be adjusted to achieve the desired voltage drop between pad 210 and functional circuit 250 while not disturbing the performance of the circuit.

Resistive device 230 may be physically separated from ESD protection circuit 220. In other embodiments, resistive device 230 may be embedded in ESD protection circuit 220, e.g. depending on the size of the ESD protection circuit 220 or the ESD protection performance of the circuit. For example, separating device 230 from ESD protection circuit 220 may improve the performance of ESD protection.

Functional circuit 250 comprises internal circuit 253 and may further comprise a buffer circuit, e.g. NMOS inverter transistors 251 and 252, disposed intermediate pad 210 and internal circuit 253. In this embodiment, the source terminal of NMOS transistor 251 may be coupled to a voltage terminal, e.g. a V_{DD} terminal. Internal circuit 253 may comprise numerous components, e.g. active and/or passive circuits (not shown in the figures) such as an input buffer, an output buffer, a pre-driver circuit, a level-shift circuit, an amplifier, a power supply, or any other circuit that provides functionality for the operation of internal circuit 253.

When an ESD pulse is present at pad 210, the ESD pulse will trigger ESD protection circuit 220 into an “on” state. ESD protection circuit 220 then redirects the ESD pulse to the V_{SS} terminal. Additionally, as resistive device 230 may also effect a voltage drop between pad 210 and functional circuit 250, the exemplary circuit illustrated in FIG. 2 may be used to protect thin gate oxide layers of NMOS transistors 251 and 252 from ESD damage.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A circuit for electrostatic discharge (ESD) protection, comprising:
a. a low capacitance ESD protection circuit coupled to a pad and a ground;
b. a first resistive device, comprising a first connection coupled to the pad and a second connection; and
c. a second device coupled to the second connection of the first resistive device and to the ground.

2. The circuit of claim 1, wherein the pad is at least one of (a) an input/output power pad or (b) an input/output signal pad.

3. The circuit of claim 1, wherein the first resistive device comprises a low impedance resistor.

4. The circuit of claim 3, wherein the low impedance resistor comprises an impedance of between about 1 ohm to 100 ohms.

5. The circuit of claim 1, wherein the second device comprises an NMOS transistor.

6. The circuit of claim 5, wherein the source of the NMOS transistor and the gate of the NMOS transistor are coupled to a common junction.

7. The circuit of the claim 6, wherein the common junction is the ground.

8. An integrated circuit, comprising:
a. a pad;
b. a buffer circuit, operatively coupled to a voltage terminal and to a ground;
c. an internal circuit, operatively coupled to the voltage terminal and to the ground;
d. a low capacitance electrostatic discharge (ESD) protection circuit coupled to the pad and the ground;
e. a first resistive device, comprising a first connection coupled to the pad and a second connection coupled to the buffer circuit; and
f. a second device coupled to the second connection of the first resistive device and to the ground.

9. The integrated circuit of claim 8, wherein the buffer circuit comprises an inverter.

10. The integrated circuit of claim 8, wherein the first resistive device comprises a low impedance resistor.

11. The circuit of claim 10, wherein the low impedance resistor comprises an impedance of between about 1 ohm to 100 ohms.

12. The circuit of claim 8, wherein the second device comprises an NMOS transistor.

13. The circuit of claim 12, wherein the source of the NMOS transistor and the gate of the NMOS transistor are coupled to a common junction.

14. The circuit of the claim 13, wherein the common junction is ground.

15. The circuit of claim 8 wherein:
a. the voltage terminal is a V_{SS} voltage terminal; and
b. the first resistive device and the second device effect a current path between the V_{SS} terminal and the pad.

16. The circuit of claim 11, wherein the NMOS has a width from about 10 μm to about 30 μm and has a length from about 0.15 μm to about 0.25 μm.

17. A method of protecting an internal circuit from electrostatic discharge (ESD), comprising:
a. coupling a functional circuit to an ESD protection circuit;
b. coupling the ESD protection circuit to a pad;
c. operatively coupling an additional circuit intermediate the ESD protection circuit and the functional circuit; and
d. using the additional circuit to effect a voltage drop between the pad and the functional circuit to protect thin oxide layers of at least a portion of the functional circuit from damage when an ESD pulse is present at the pad.

18. The method of claim 17, wherein using the additional circuit further comprises a device adapted to increase resistance between the pad and the functional circuit.

19. The method of claim 18, wherein the resistance is from about 1 ohm to about 100 ohms.

20. The method of claim 17 further comprising discharging the ESD pulse to a Vss terminal when the ESD pulse is coupled to the pad.

21. The method of claim 17 further comprising disabling a current path formed by the coupling of the functional circuit to the ESD protection circuit when no ESD pulse is coupled to the pad.

22. The method of claim 21, wherein discharging the ESD pulse further comprises punching through a MOS transistor.
